(19) United States
(12) Patent Application Publication
(10) Pub. No.: US 2010/0207300 A1
(43) Pub. Date: Aug. 19, 2010

(54) MOULDING OF ARTICLES

(75) Inventor: David Brian Johnson, Rickmansworth (GB)

Correspondence Address: MERCHANT & GOULD PC, P.O. BOX 2903, MINNEAPOLIS, MN, 55402-0903, US

(73) Assignee: Natural Resources (2000) Limited, Rickmansworth (DE)

(21) Appl. No.: 12/678,232

(22) PCT Filed: Sep. 15, 2008
(86) PCT No.: PCT/GB08/03104

§ 371 Date: Mar. 15, 2010

(30) Foreign Application Priority Data
Sep. 14, 2007 (GB) 0718030.0
Apr. 18, 2008 (GB) 0807168.0

(51) Int. Cl. B06B 1/20; B29C 41/08; B28B 1/26

(52) U.S. Cl. 264/442; 264/517; 425/84

(57) ABSTRACT

A moulding machine for paper fibre articles has a mould (107, 1707) made from sintered particles. A measured shot of liquidised pulp is drawn through the mould using a piston (109, 1709) on the other side. The article is dried in situ with pressurised hot air. Large moulds may be fabricated by welding together sintered sections. A method of preparing the fibres is by liquidisation.

The present invention relates to the moulding of articles from suspensions of fibres or other particles and to moulds and moulding machines for use in such processes.

Items moulded from paper fibre pulp have in the past generally been items such as egg boxes and bed pans which can be produced in very large numbers, are unsophisticated in shape and do not require any very high standard of surface finish. These limitations have been imposed by the technology employed in the moulding of the articles which traditionally have been moulded using permeable moulds formed of metal mesh. The construction of such a mould is a lengthy and expensive procedure limiting this technology to items to be produced in very substantial numbers. The quantity of liquid which can be expelled from the deposited paper fibres in the mould prior to demoulding is limited by the poor level of surface smoothness obtained using such mesh moulds and this in turn limits the strength of the product as it is demoulded. Because of this, only shallow items such as egg boxes can be made this way without collapsing under their own weight prior to drying. The amount of water left in the product makes drying the product an energy intensive procedure.

Conventional pulp moulding tools used in the industry today are normally constructed using cast phosphor bronze. This is suitably contoured and profiled to suit the product to be produced and ventilated with a small 3 mm hole approximately every 1 cm over the entire surface, allowing air to pass through the tool. The casting surface is covered with a fine wire screen to filter and separate pulp fibres from the water drawn on to its surface by vacuum.

This present method only permits low pressures to be applied, normally vacuum, as any greater force will cause the intersections of the wire screen to separate or lift from the supporting casting, clamping the pulp fibres, and result in blocking or blinding of the tool surface.

It has been proposed to construct porous moulds from other materials, e.g. Japanese Patent Publication JP60009704 discloses a gas permeable mould for use in wet shaping a fibre slurry, the mould being produced from particles such as glass or plastics beads bonded together with a binder such as an epoxy or a polyester resin. Nonetheless, in practice moulds for use in making articles from paper fibre slurries are still made using the traditional wire mould method. This may be because the construction of moulds according to this teaching will require the mixing of glass beads in precise proportions with resin binders which by virtue of their viscosity are difficult or impossible to mix properly with the beads, the formation of the somewhat intractable mixture thus formed into a shaped mould, and the curing of the mould by the application of heat over a prolonged period. The resulting method of mould manufacture presents substantial practical difficulties.

The present invention in its various aspects aims to overcome some or all of the problems outlined above.

The present invention provides method of forming a moulded article comprising:

feeding a suspension of particles in a suspending liquid to the moulding surface of a porous mould comprised of bonded particles, and

removing said suspending liquid via the pores of said porous mould to deposit said suspended particles on said mould surface as a shaped article.

The suspended particles may be fibres, for example cellulosic fibres. The suspended particles may be paper fibres.

The bonded particles may be bonded by adhesive. The bonded particles may be glass or of a plastics material. The bonded particles may be metal. The bonded particles may be sintered together. The bonded particles are phosphor-bronze or nickel coated copper.

The suspending liquid may be forced through the mould by applying a pressure difference across the mould. The suspending liquid may be forced though the mould by applying suction to the opposite side of the porous mould to that to which the suspended particles are fed. The suction may be applied though the action of a piston in a chamber closed off by the mould. The method may include expelling further suspending liquid from said moulded article by applying pressure to the article against said porous mould surface, which pressure to the article may be against said porous mould surface. The applying of pressure maybe with a rubber former.

The method may comprise passing air above ambient temperature through the deposited suspended particles and the porous mould from the side of the porous mould on which the particles are deposited. The air passed is preferably at a pressure of 1 to 2 bar above atmospheric pressure on the deposition side of the mould and a temperature of 400° C. to 500° C. Alternatively the air passed may be at a pressure of 7 to 10 bar above atmospheric pressure on the deposition side of the mould and a temperature of 60° C. to 70° C.

The method may comprise placing the moulded article between two porous moulds and passing heated compressed air through the moulds and the article.

The method may comprise depositing a second layer of particles on top of the first layer deposited particles by feeing more suspended particles in a suspending liquid to the side of the mould on which the first layer is deposited and removing the suspending liquid via the pores of said porous mould to deposit the second layer.

The method may comprise adding an additive to the suspension. The additive may comprise colouring or herbicide or germicide or beeswax or decorative particles, or a combination thereof.

The method may comprise passing a backwash liquid through the mould in the opposite direction from that in which the suspending liquid passed through the mould. The method may comprise introducing ultrasound into the backwash water passing through mould.

The method may comprise preparing the particle suspension by liquidising fibrous material.

The method may comprise pressing a flexible impermeable membrane against the article using pressure applied behind the membrane. The membrane may, for example, form an internal screw thread into the article.

The invention further provides a porous mould comprised of bonded particles.

The bonded particles may be bonded by adhesive.

The bonded particles may be glass or of a plastics material.

The bonded particles may be metal.

The bonded particles may be sintered together.

The bonded particles are preferably of phosphor-bronze, or may be nickel coated copper.

The particle size for the particles of the mould is preferably between 0.5 and 0.7 mm.

The invention also provides a moulding machine comprising the said mould.

The moulding machine may comprise a port for feeding as suspension of particles to one side of the mould. The moulding machine may also comprise a cavity to the other side of the mould, and a port for applying suction to the cavity. The moulding machine may comprise a cavity, to the other side of the mould, receiving the mould, and a piston for applying suction to the cavity and hence to the mould. The mould may be removably received in the cavity.

The moulding machine may comprise a port for supplying backwash water into the cavity.

The moulding machine may comprise a port for supplying compressed air to said one side of the mould.

The moulding machine as claimed may comprise a former advancable into the face of the mould on the one side.

The mould maybe in at least two separable parts.

The moulding machine may comprise comprising a liquidiser connected to supply the suspension to one side of the mould.

The invention further provides a method of manufacturing a porous mould comprising:

providing a space between male and female master moulds,

filling the space with metal particles, and

sintering the particles to bond them together,

wherein the male mould is of a compressible material.
The compressible material may be resiliently compressible or alternatively deformably compressible. The compressible material may be clay or plaster.

The invention also provides a method of manufacturing a porous mould comprising:

forming porous sections of bonded particles, and

laser welding those sections together.

The said sections may be of bonded metal particles, which, for example may be of phosphor-bronze or nickel coated copper.

The invention further provides a method of manufacturing a porous mould comprising:

mixing particles with an adhesive,

shaping the mixture into a mould, and

setting the adhesive.

The adhesive may be set with ultra-violet light. The particles may transmit ultra-violet light. The particles maybe made of glass, or maybe made of acrylic.

Various further aspects of the invention are set out below.

In a first aspect the invention provides a method for forming the surface of a porous mould comprising depositing a layer of particles over a shaped surface, mixing intimately said particles with a light curable adhesive, before or after depositing said layer, and curing said adhesive by exposure to light to bond said particles together, the quantity of adhesive being such that the bonded layer of particles is porous.

The particles are preferably beads, preferably spherical beads. Preferably, the smallest dimension of the particles is less than 2 mm, or more preferably less than 1 mm, e.g. 0.2 to 0.8 mm.

Suitable materials for the beads include glass and plastics. The use of acrylic plastics is particularly preferred.

Where glass is employed, it may be preferable for the glass to be coated with materials adapted to improve the bonding of the beads to light curable adhesives. Suitable materials are known in the art.

The particles may include, preferably as a minor amount, particles which are not beads. These may be needles, fibres, tubes or hollow spheres. Like the beads described above they may be of glass or plastics. Preferably, the proportion of such particles to the beads is less than 50 percent by weight of the particulate material, more preferably less than 10 percent by weight.

Whilst the beads are preferably of acrylic plastics such as polymethylmethacrylate, they may also be of polyester, polystyrene or polyalkylene (e.g. polyethylene or polypropylene) or other plastics materials, optionally in admixture.

Preferably, all or substantially all of the particles employed are transparent to the light used for curing which is preferably UV light.

The shaped surface may be a mould former over which the particles are spread in a layer prior to curing of the adhesive. Many methods may be employed for forming the layer of beads on the shaped surface. The particles may be mixed with the adhesive and then spread as a paste on the shaped surface. Alternatively, the beads may be deposited on the shaped surface by one of a number of methods and then treated, e.g. sprayed, with the adhesive to form the required mixture of beads and adhesive.

The layer of beads and adhesive in admixture on the shaped surface may be further shaped and compacted by the application to the surface of said layer of a second mould former. This may take the form of a solid mould former or may take the form of a membrane which is forced against the surface of the layer by hydraulic or pneumatic pressure. Curing light may be applied through either the male-form former if this is transparent, directly against the surface of the layer, or through any member employed to press the surface of the layer. The membrane or shaped surface used to compress the layer is therefore itself preferably transparent.

After the layer of particles has been cured, one or more layers of larger particles are preferably deposited thereon and each bonded to form a porous reinforcement for the surface layer, preferably by the use of light-curing adhesive.

The adhesive is preferably an acrylic adhesive. The viscosity of the adhesive is preferably chosen having regard to the diameter of the particles to be bonded but is preferably a low viscosity such as from 30 to 150 mPas

(Brookfield@25° C.), e.g. about 70 mPas.

After the porous mould has been removed from the former, a UV-curing adhesive, preferably of a viscosity down to 5 mPas may be drained through the mould to thinly coat all the particulate and the junctions between the particles. Excess may be drawn off by vacuum prior to UV curing. This process may be repeated to adjust the mould strength and porosity as desired. The quantity of adhesive relative to the quantity of particulate material will need to be chosen having regard to the nature and size of the particles but by way of guidance is preferably in the range of 1:3 to 1:8 adhesive weight:bead weight, more preferably 1:4 to 1:5.

The invention includes in a second aspect a porous mould comprising a moulding surface composed of particles bonded to one another by a light cured adhesive, preferred features of the porous mould being as indicated above.

The invention includes in a third aspect a method for forming the surface of a porous mould comprising depositing a layer of fusible plastics particles over a shaped surface and sintering said layer. The particles may be plastics beads, e.g. polypropylene beads and the heat input employed is preferably controlled to produce a desired degree of porosity.

The thickness of the preferably from 2 mm the to 8 surface layer thus formed mm. Preferred materials is are polyethylene or polypropylene beads. Preferred particles are diameters from 0.2 mm to 2 mm.

In a typical process of this type, a measured amount of plastics particulate may be mixed with a soluble particulate such as sodium chloride and the mixture may be compressed between two heat conductive (e.g. metal) formers. The assembly may be heated, suitably in an oven, to allow the plastics to melt sufficiently to flow between the intervening soluble particles to the degree that at a continuous structure is formed containing linked porosities containing the soluble particulate. The soluble particulate may then be leached out to leave a smooth surface unskinned, porous structure. Typically the resultant mould material may be about 55% plasticsj45% void (by volume). The process can be conducted so as to build-up layers having increasing porosity going away from the mould surface.

Larger particles may be bonded to the surface of the sintered layer to reinforce the layer prior to its removal from the surface on which it is shaped.

In a fourth aspect, the invention provides a method for forming the surface of a porous mould comprising applying a porous sintered plastics particle sheet to a shaped surface, and forming the sheet to the surface by the application of heat. For use in this aspect of the invention, sheets formed by sintering plastics beads such as polypropylene beads are available which possess suitable porosity. These may be applied over a male form shape and may be thermoformed to take up the shape of the male form. As described above, the resulting shaped layer of sintered particles may be reinforced to form a porous mould.

In a variant of this process, sections of such a porous sheet material may be bonded to one another as walls to fabricate a three dimensional mould shape, e.g. a box-shaped mould. The mould may be reinforced, e.g. by bonding ribs, bulkheads, or frames on the non-mould face side of the walls of the mould.

In a fifth aspect the invention includes a method of forming a moulded article comprising feeding a suspension of particles, preferably of fibres, in a suspending liquid to the moulding surface of a mould as described above according to any of the aspects of the invention and withdrawing said suspending liquid via said porous mould surface to deposit said particles on said mould surface as a shaped article.

Preferably, such a method includes expelling further suspending liquid from said shaped article by applying pressure to the article against said porous mould surface. This may be done by pressing a flexible impermeable membrane against said article, suitably by pneumatic or hydraulic pressure applied behind the membrane. The membrane will generally also compact the moulded product and give it a smoother non-mould surface which can be textured if the membrane has a surface pattern. Where shaping by the membrane is desired it is applied whilst the pulp is semi-wet, i.e. before it is fully drawn down to a crinkled surface by the vacuum. Further drying may be carried on after removing the membrane and before demoulding.

The particles in the suspension to be moulded are preferably cellulosic fibres, e.g. paper fibres. Optionally, one may deposit a first layer of high grade paper fibres to form the surface of the moulded article and then reinforce the surface layer thus formed using lower grade paper fibres to form the body of the article. The second layer may contain fibres such as glass fibres, plastics fibres or straw fibres for increased strength and to reduce shrinkage. Optionally, a further layer of higher grade paper fibres may be deposited last to form the other surface of the article.

Materials for the further treatment of the article in its wet state may be passed through the porous mould either from the interior of the mould to the exterior or in the opposite direction as a backwash. These may include resins for binding the particles or rendering the article impermeable to liquids. To facilitate cleaning of the mould after the moulded article has been removed, backwashing may again be employed. Preferably, the mould porosity is such that the mould is not so permeable to ‘liquid flow that water will drain through at a significant rate without the application of pressure, otherwise it may be difficult to fill the space behind the mould with backwashing liquid under pressure. If the mould surface layer is hydrophobic, better resistance to water flow may be achieved at a given porosity.

Air may be passed through the porous mould in either direction in order to dry the article prior to it being demoulded. Subjecting the article to some hot air drying in the mould may serve to strengthen the wet article and to reduce any subsequent distortion which occurs during drying after demoulding.

Air may be passed in the backwash direction at the same time as back wash liquid or on its own to assist in lifting residual particles from the mould surface. Also a pressure wash, spray may be used on the mould surface in cleaning it of residual particles.

The invention includes in a sixth aspect a moulding machine comprising a mould box having a base and sides defining a cavity for receiving a mould insert, a porous mould insert removably received in and closing said cavity with a moulding surface of the porous mould insert facing out of said mould box and a space within said mould box covered and closed by said mould insert, said mould box having at least one conduit through its base or sides to said space, means for covering said moulding surface of the porous mould insert to define a mould cavity, and means for supplying a suspension of particles in liquid to the interior of said mould cavity to be deposited on said moulding surface to form a moulded article.

The porous mould insert is preferably a porous mould as defined above according to previous or following aspects of the invention. The use of a separate mould insert in a mould box provides flexibility in changing the article to be produced by a moulding machine of this general type.

Preferably, the mould box includes conduits into said space for the application of suction to withdraw air and liquid through the mould insert and also one or more separate conduits for the injection of liquid or air into said space in order to pass in the opposite direction through the porous mould insert.

The means for closing the porous mould insert to form a mould cavity may of course be a second mould insert contained in a second mould box, the two porous mould inserts together defining the shape of the article to be moulded such as a bottle split axially between the two porous mould inserts. The suspension of fibres or other particles may then be conveniently be supplied through the neck of the bottle or like moulded article into the mould cavity.

In a seventh aspect, the invention provides a porous mould having a moulding surface formed by sintering metal particles. Preferably, the particles are essentially spherical in shape. Suitably they are of phosphor-bronze. Generally, it is found that a single size of metal particle may be used throughout the depth of the porous mould. A mould of from 3 to 8 mm thickness is generally found to have adequate strength.

The spheres are preferably of from 0.25 to 1.00 mm diameter.

Preferably, paper fibre stock is filtered through the porous mould to deposit a moulded form thereon which is dried by a process including the step of applying pressure to squeeze water therefrom, preferably by the application of heated high pressure air to the mould.

The invention will be further described and illustrated with reference to the accompanying drawings in which:—

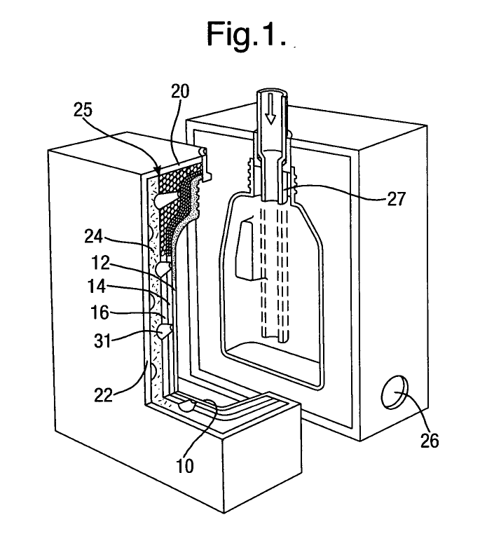

FIG. 1 shows a mould according to the invention in cut-away perspective view;

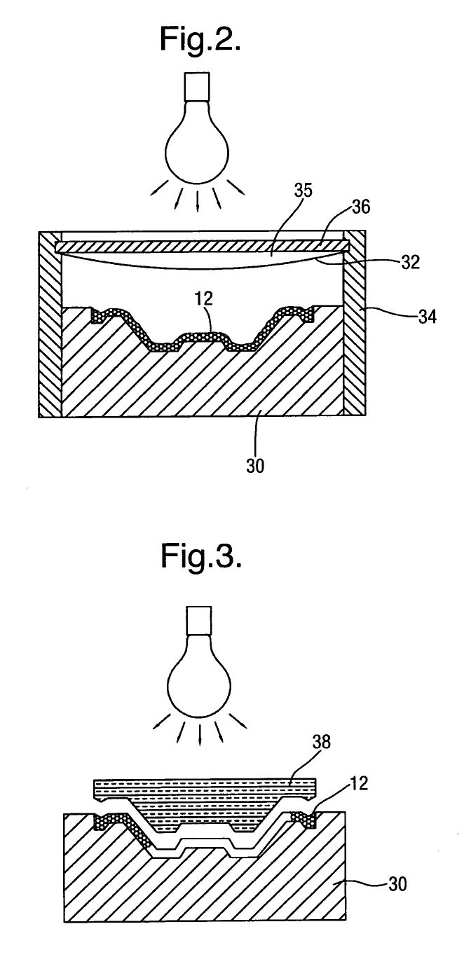

FIG. 2 shows a cross-section through a male-mould form in use in producing a mould according to the invention, including the use of a transparent membrane for compacting the mixture of particles and light curable adhesive employed;

FIG. 3 shows a cross-section through a male-form surface in use in making a porous mould according to the invention including the use of a transparent female form for compacting the mixture of particles and light curable adhesive;

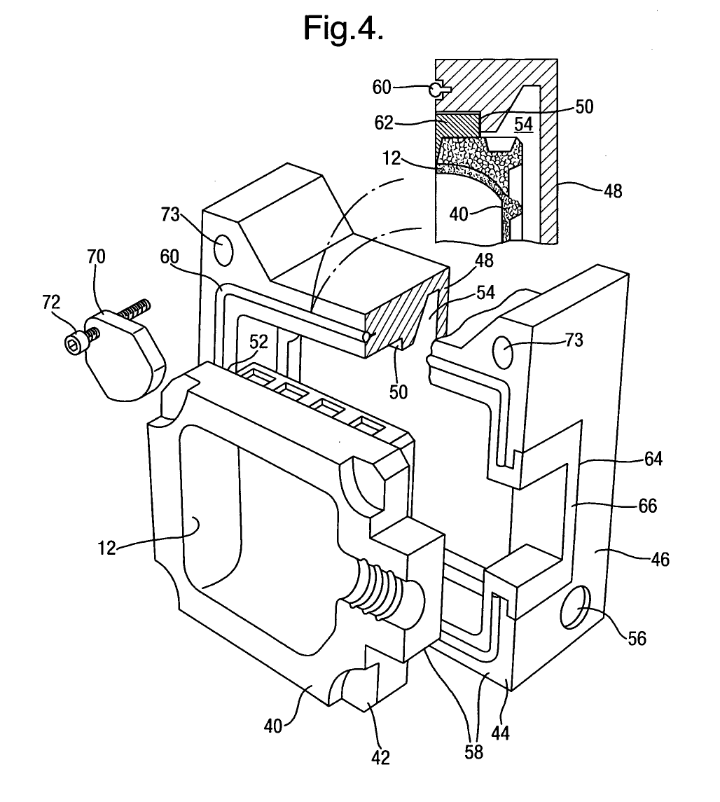

FIG. 4 shows the mould box and mould insert of a moulding machine according to the invention;

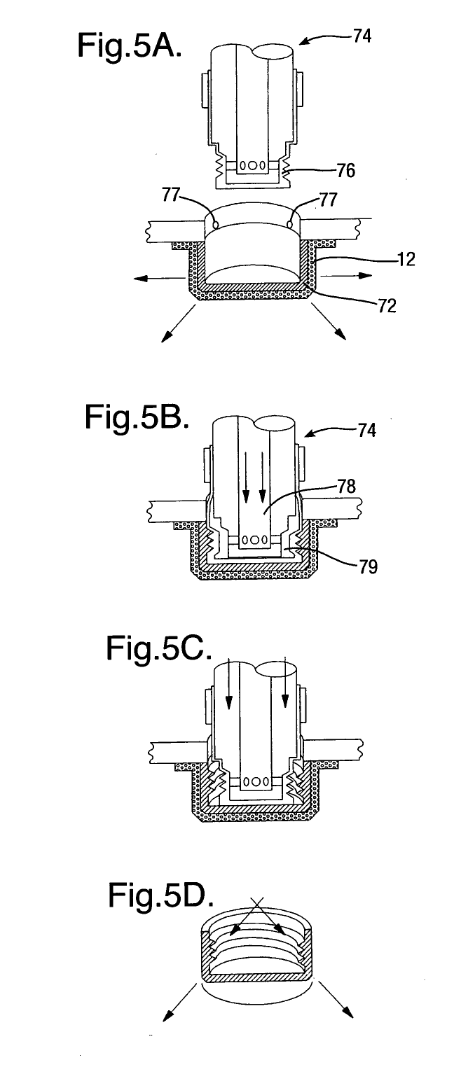

FIGS. 5A to 5D show a cross-section through the mould cavity of a moulding machine according to the invention in use in moulding an internally threaded article;

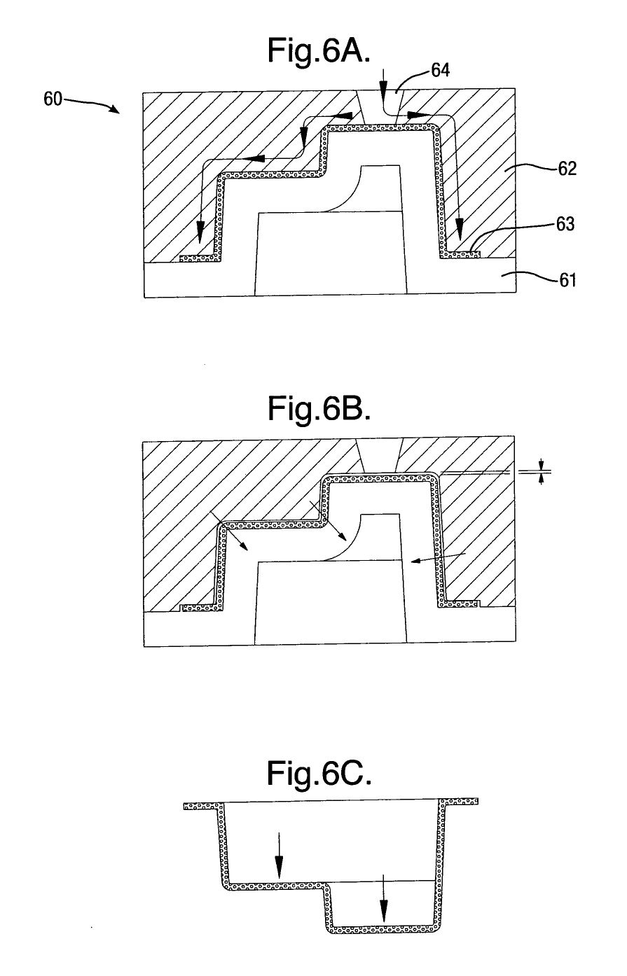

FIGS. 6A to 6C show an alternative process for making a mould, which is suitable for deep moulds,

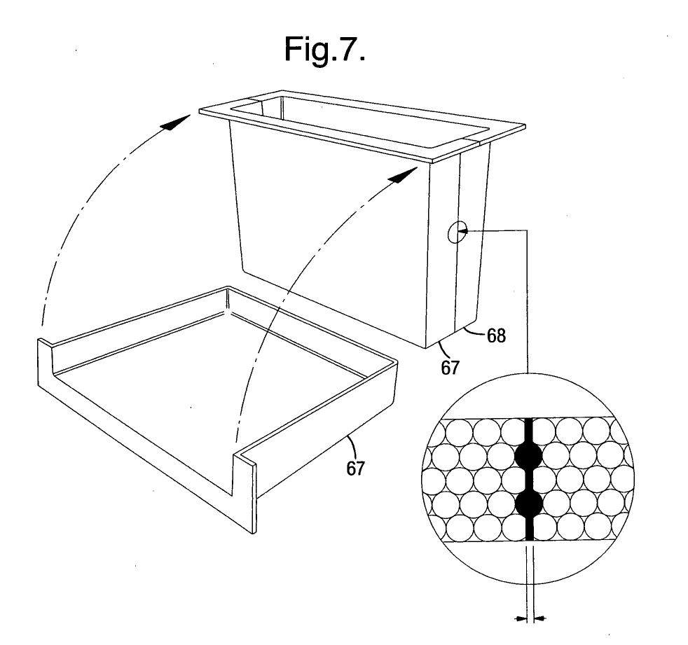

FIG. 7 illustrates a process of welding sections of filter together to make moulds,

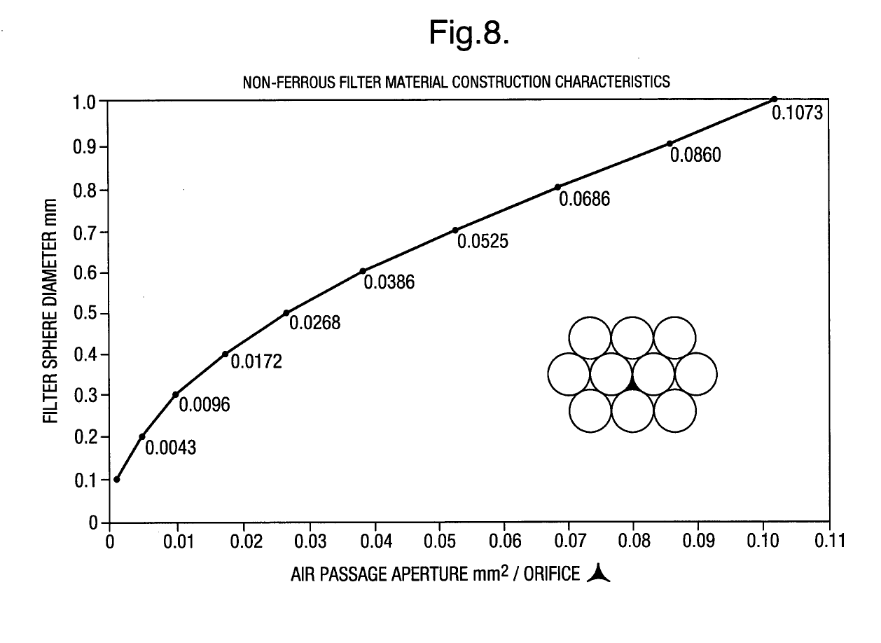

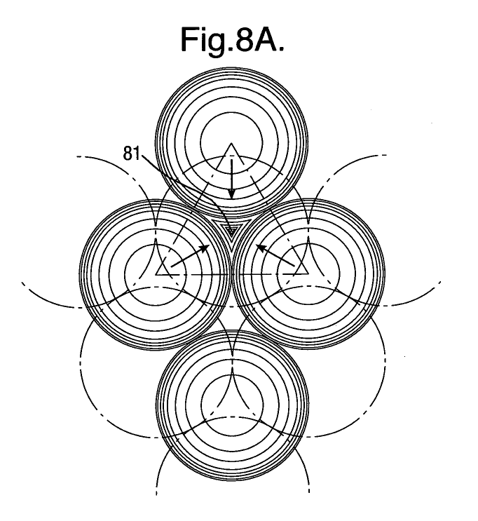

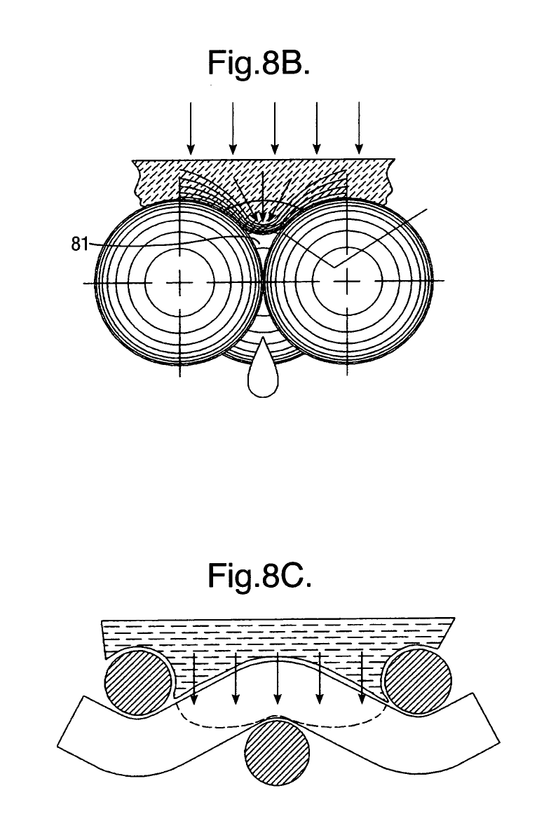

FIG. 8 is a graph relating to particle diameter to pore size for a mould in accordance with the invention;

FIGS. 8A to 8C illustrate features and advantages of moulds made from spheres,

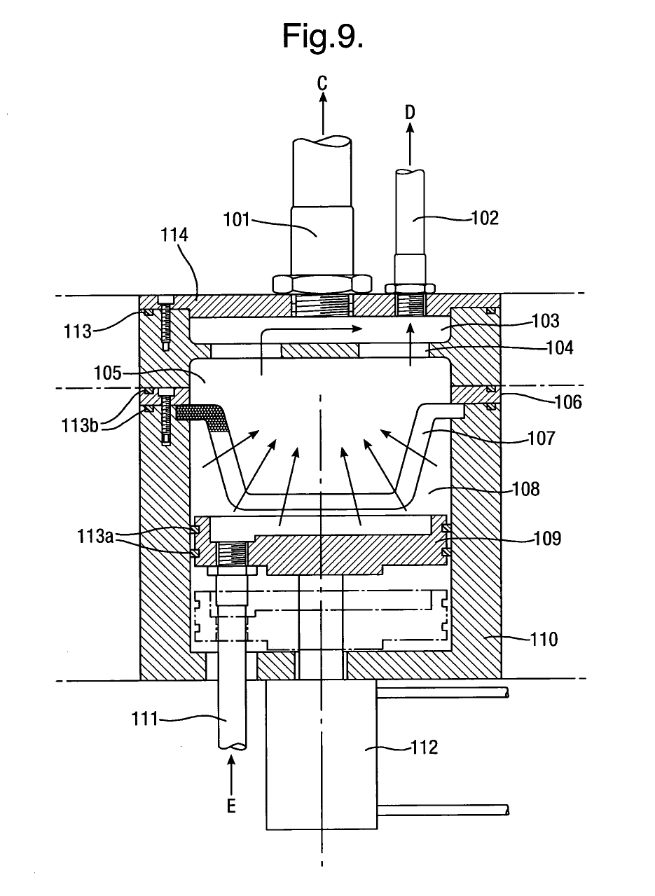

FIG. 9 is a cross-section through a moulding apparatus of the invention in a first phase of operation;

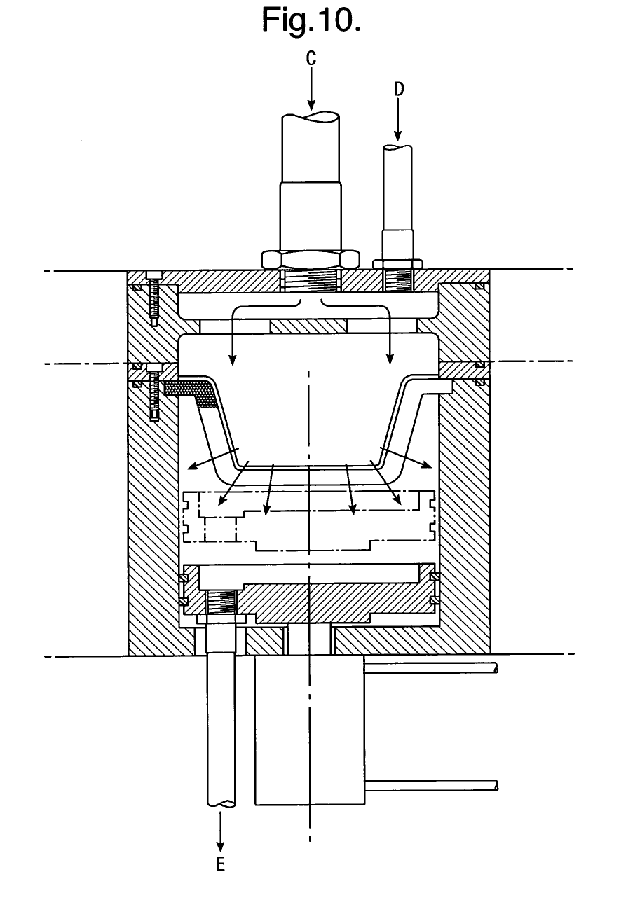

FIG. 10 is a similar cross-section of the apparatus of FIG. 9 at a second stage of operation;

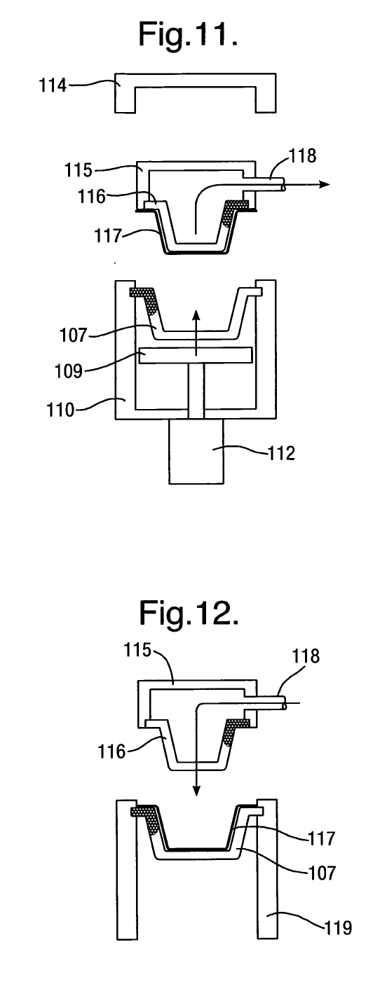

FIGS. 11 to 15 schematically illustrate the drying and removal of a moulded object produced in the mould of FIGS. 9 and 10;

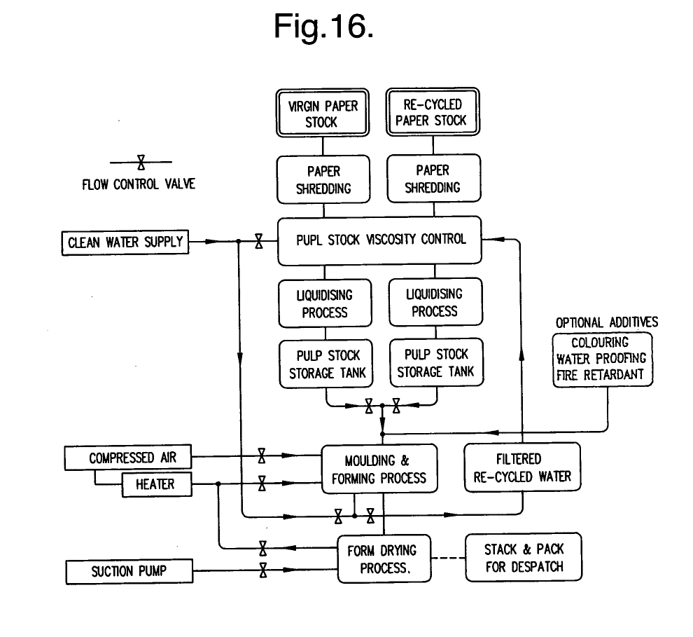

FIG. 16 is a schematic flow diagram of the complete moulding operation described with reference to FIGS. 9 to 15.

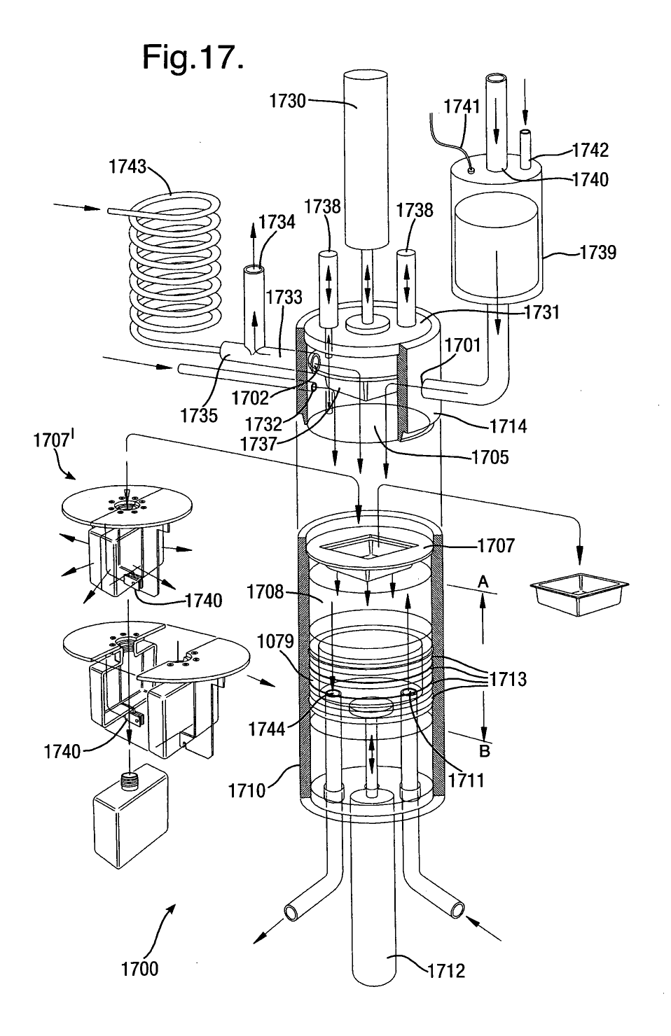

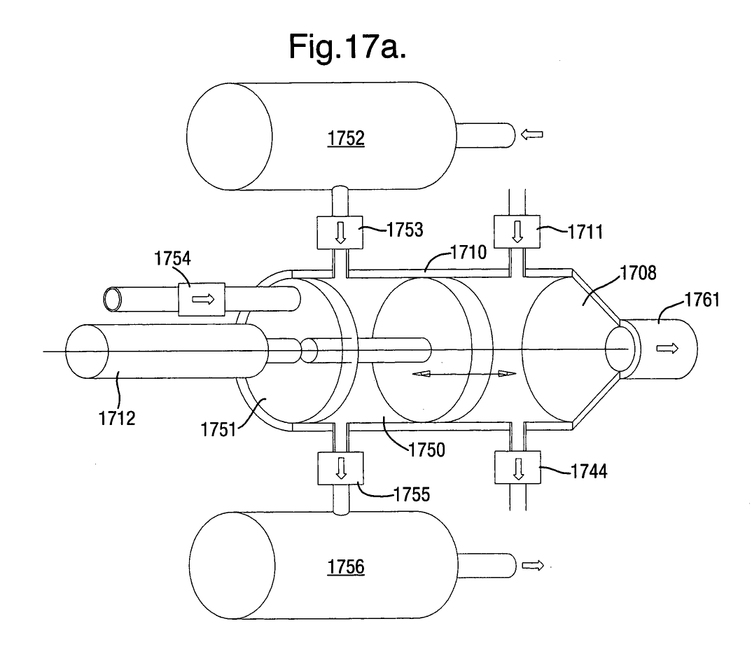

FIG. 17 shows an alternative form of moulding apparatus according to the invention,

FIG. 17a shows an arrangement for generating compressed air and/or vacuum from the piston,

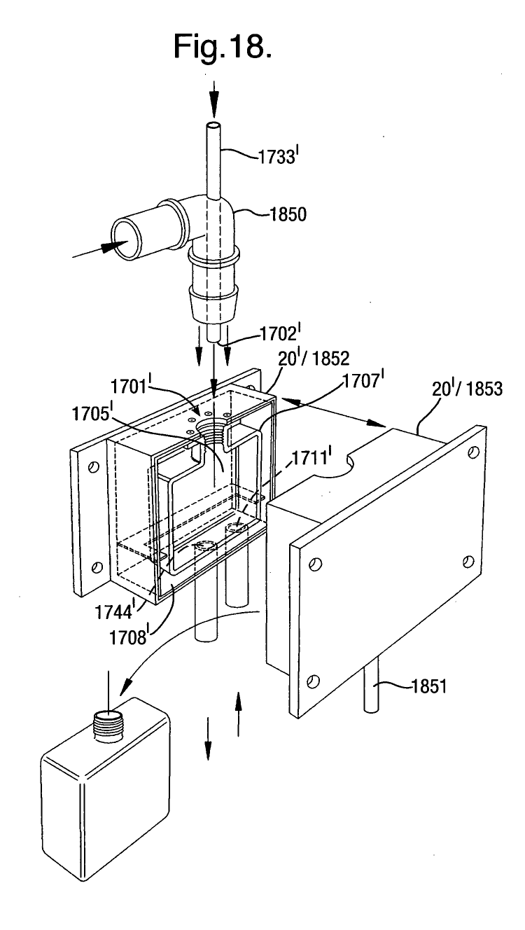

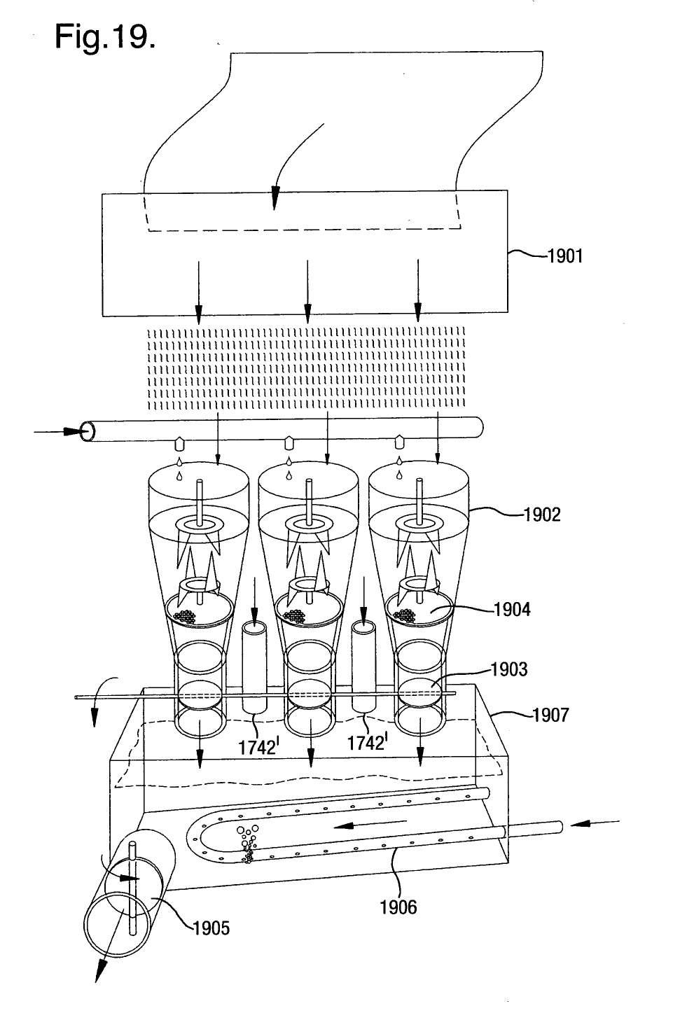

FIG. 18 shows an alternative form of moulding apparatus for closed moulds, such as bottles,

FIG. 19 shows a liquidising apparatus for supplying the pulp in accordance with the invention.

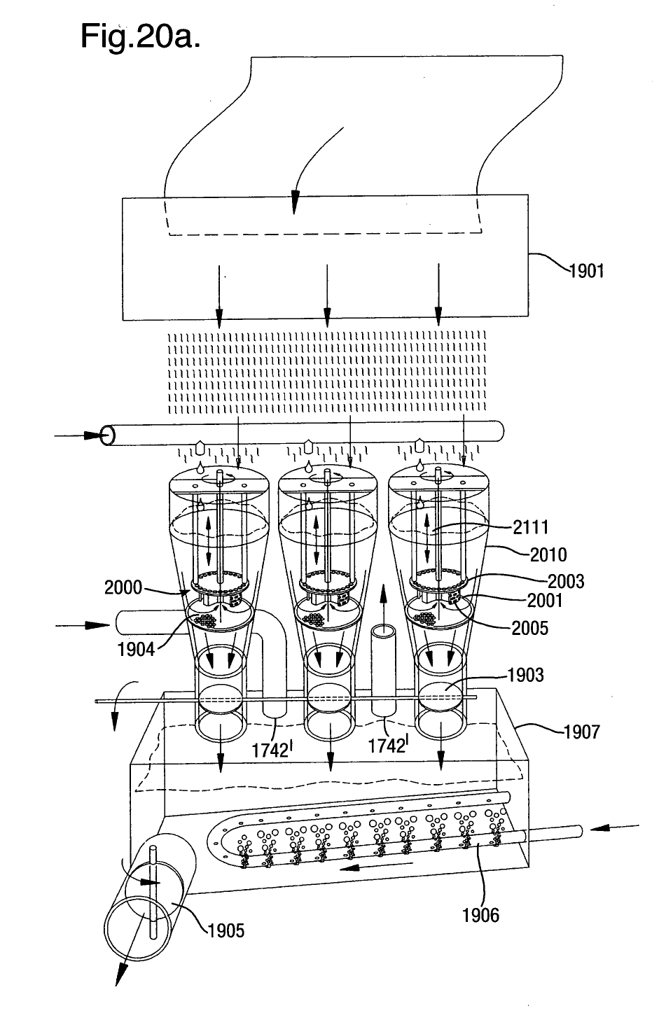

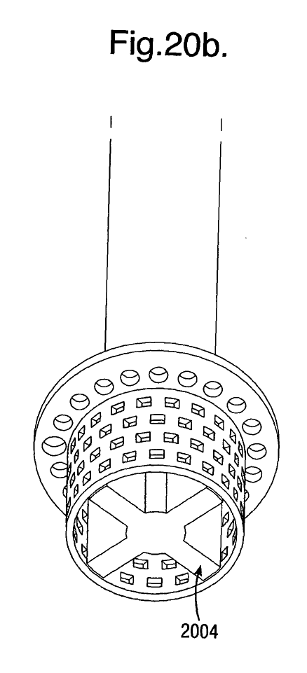

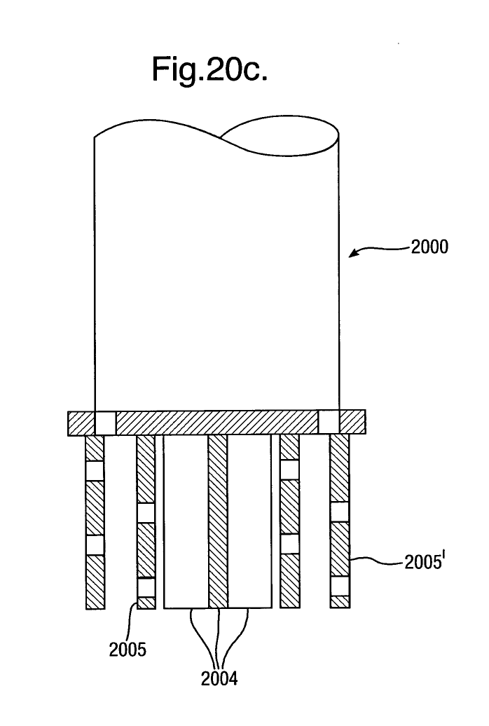

FIG. 20a shows a slotted liquidizer,

FIG. 20b shows an oblique view of the slotted liquidizer head,

FIG. 20c shows slotted liquidizer head having concentric slotted sections.

As shown in FIG. 1, a mould according to the invention comprises a surface layer 12 of small diameter beads (e.g. 0.3 mm) bonded to one another using a light-curable adhesive which does not fill all of the voids between the beads, so that the resulting layer is porous. Behind this, there is shown a layer of larger diameter beads 14 bonded in a similar manner and acting to reinforce the surface layer 12. Still larger diameter beads 16 form a further reinforcement behind the layer 14. To facilitate draining of liquid through the mould, cavities 31 are provided running through the larger diameter bead layers.

The thick multilayer construction 12, 14, 16 of the mould of FIG. 1 provides considerable strength. In many applications a single layer of 5 to 10 mm thickness of the small diameter beads will provide sufficient strength. The moulds shown in FIGS. 6, 7, 9 to 15 17 and 18 are shown having such a single layer, as is preferred in most applications.

The porous mould is supported as a mould insert 10 in a mould box 20 having sides and a base 22. The bottom 25 of the porous mould insert 10 stops short of the base 22 of the mould box leaving a cavity 24. A port 26 communicates with the cavity 24 for the application of suction to remove liquid from the mould.

The mould insert shown in FIG. 1 is for a bottle and is provided in two halves that can be separated in order to remove the bottle formed inside. Moulds for all sorts of articles can be provided. If the articles is open, such as an egg tray then the mould insert can also be open, i.e. does not need to be in two halves.

In the case of a closed mould, e.g. for a bottle as shown in FIG. 1, a tube 27 is provided to introduce the pulp through the neck. The dotted lines show an alternative long tube that reaches down to a few centimetres from the bottom of the bottle. After the pulp mixture is supplied filling the mould and suction is being applied to draw the fibres on to the mould, further pulp mixture, clean water or further pulp followed by water is introduced through the tube so that the level of mixture is maintained for a while so that the upper parts of the mould are not left without a supply of pulp fibres while the vacuum is applied which might result in only a thin coating of fibres there.

After being removed from the mould, a bottle can be made waterproof by being lined with latex. This can be done by filling the bottle with liquid latex and pouring out the excess.

A first example of the manufacture of the mould insert 10 is illustrated in FIGS. 2 and 3. In FIG. 2, a former 30 is used to define the shape of the surface 12 of the mould insert 10. A layer of a mixture of small diameter beads and light curable adhesive is spread as a layer 12 over the mould former 30. This layer may for instance be of glass or acrylic beads of approximately 0.3 mm diameter mixed well with a light curable acrylic adhesive having a viscosity in the region of 70 mPa (Brookfield@15° C.) in the proportion of, for acrylic beads, 1:4.5 adhesive weight to bead weight. (For glass or other material this ratio is adjusted by the relative densities of acrylic and the material.) This proportion ensures that the beads are only coated with the correct amount of adhesive to ensure that the pores between them remain open. Such a mixture has the consistency of wet granulated sugar and is easily applied as a paste over the former 30. To even the paste layer, a flexible membrane 32 is provided. This is secured at its edges to the tops of walls 34 which surround the former 30. A gas space 35 is defined between the membrane 32 and a top 36 applied thereover and gas is injected into the gas space to drive the membrane 32 down over the layer 12. The membrane 32 is transparent, as is the top 36 and UV light is applied for few seconds through the top 36 and the membrane 32 to cure the layer 12.

Thereafter, if a stronger mould is required, larger diameter beads similarly mixed with adhesive are applied as subsequent layers over the layer 12 and cured in a similar manner, longer curing times generally being needed in these later stages.

In the alternative arrangement shown in FIG. 3, the former 30 is provided as before and a layer 12 is built up in the same way. A transparent plastics (e.g. clear acrylic) block 38 having a surface shape complementary to that of the former 30 is pressed down over the layer 12 to compact and even the layer and UV light is applied through the block 38 to cure the layer 12.

The male former 30, the membrane 32 and the block 38 may each be coated with release materials to facilitate removal of the layer 12 therefrom, suitable release materials being known, such as silicone waxes, organic waxes and PTFE. Also if portions of the former 30 prove sufficiently steep that the bead-adhesive mixture runs down before it is set this can be mitigated by the application to the former 30, membrane 32 and block 38 of grease or adhesive to reduce the flow the mixture.

As an alternative to acrylic the beads can be made of glass.

In the part of a moulding machine shown in FIG. 4, a mould insert 40 is provided which is a porous mould prepared as described with reference to FIGS. 1 to 3. It is shaped to provide shoulders 42, one at each corner, by which it may be held down in place as described below and it has a surface 12 of light-cured beads.

The insert 40 fits into the open top of a mould box 44 having sides 46 and a base 48. The sides 46 include an inwardly projecting ledge 50 providing an abutment against which an outwardly projecting flange 52 on the exterior of the mould insert locates leaving the bottom of the exterior of the mould insert above the bottom 48 of the mould box so as to define a cavity 54 therein. The mould box is provided with a number of ports leading into its interior. A first port 56 is for the injection of materials into the cavity 54 and is provided with a valve by means of which the port 56 may be closed. A port at the opposite end of the mould box (not shown) is for the suction of materials from the cavity 54.

The mould box 44 has a mating face 58 against which a similar mould box containing a similar mould insert 40 may be mated (for example, to produce closed articles such as bottles). A sealing bead 60 is provided extending around the mating face 58. As shown in the enlarged detail in the figure, edge portions 62 of the mould insert 40 are made non-porous by being flooded with adhesive which is subsequently cured by the application of UV light. This is to prevent the deposition of paper fibres in the join between the two mould insert halves.

The mould box 44 has in one side wall a cut-away 64 in which is received a neck-locating filler block 66. This receives the neck portion of the mould insert 40. For moulding articles which do not have a neck (e.g. an open article), the filler block 66 may be replaced by a solid block and the mould half 40 may be replaced by an appropriately shaped mould insert. The supply of paper fibre slurry may then be made through an aperture in a closure plate (or chamber—see later examples) applied against the surface of the mould insert 40.

The mould insert 40 is retained in the mould box by clip members 70 (only one shown in the Figure for clarity) retained in the mould box by bolts 72 (which screw into threaded holes 73 in the mould box) and bearing on the shoulders 42. The mould inserts 40 are therefore easily removable from their respective mould boxes and the moulding apparatus can rapidly be set up using alternative mould inserts to produce differently shaped articles.

In use, a supply of paper fibre slurry is pumped into the interior of the mould. For a closed mould that is through, for example, what is to be cast as the neck of the bottle defined by the mould shape, and for an open mould it is pumped into the chamber, or through the closure plate, sealed against the mould. Suction is applied to the mould cavity 54 to withdraw liquid through the porous mould depositing fibres on its interior to define the article. (For a closed mould suction is applied to the cavity 54 of both mould halves.) An even coating of fibres is generally formed if the ventilation of the mould with pores is even over the mould.

The port 56 may be employed for injecting backwashing liquids. Drying gases are applied through the neck in a closed article, or into the chamber, or plate, sealed over the mould in the case of an open article ventilating through 56.

By virtue of the fine grain finish obtainable in the surface layer 12 of the mould insert, articles may be produced which require a good quality surface finish. Furthermore, the surface finish may be provided with one or more effects such as simulated wood graining or leather graining simply by incorporating these into the pattern cut on the male former 30 used in producing the surface layer 12.

Further by virtue of the fine grain surface finish of the mould insert 40, the quantity of water required in the moulded article to allow successful demoulding is much lower than using a wire mesh mould. This in turn allows articles with a much deeper cavity to be produced, which articles will not collapse prior to drying (as happens with traditional wire mesh moulding), and permits the use of techniques designed to expel liquid from the article produced in the mould prior to demoulding. One may employ a membrane generally similar to that shown in FIG. 2 for the purposes of applying pressure to the interior of the moulded article to expel water through the porous mould. In the case of a bottle mould as shown in FIG. 4, or any other closed article, one may introduce a balloon through the neck of the bottle and inflate it to press the inside of the bottle against the mould insert surface.

As shown in FIGS. 5A to 5D, one may produce by this type of technique an article having a shaped internal surface in a manner not previously possible, the example here being a screw cap for a bottle. Thus, FIG. 5A shows a porous mould having a mould surface 12 on which has been deposited an article consisting of a layer 72 of paper fibre pulp and into which is inserted (FIG. 5B) a retractable hollow mandrel 74 carrying on its outside a flexible former 76 in the form of a shaped rubber (e.g. latex or silicone rubber) cup sealed at its mouth to the exterior of the mandrel 74 but in its interior defining a space for receiving a fluid 78, which may be for example a pressurised gas or an incompressible fluid such as water. The fluid is pumped up through the hollow mandrel and into the space 79 to drive the rubber cup 76 against the interior surface of the pulp article as suction is applied from the back of the porous mould. The cup 76 bears a shape defining a thread 80 which is impressed into the interior surface of the moulded article 72. Preferably pressure inside the cup is made to oscillate (while preferably remaining positive); this compacts the paper fibres of the article, conforms them better to the shape of the article and aids the removal of the water from the fibres.

Thereafter, the incompressible fluid 78 is withdrawn from the mandrel sucking the cup back on to the mandrel so that it may be removed from the moulded article without damaging the compressed thread form. Alternatively or additionally the cup 76 is collapsed by introducing, via a port 77 communicating with the region (initially an interface) between the cup and the moulded article another fluid, preferably compressed air. This helps keep the moulded article in place next to the mould surface rather than being drawn away from it in places by adhesion to the cup.

Thereafter, the moulded article 72 may be removed from the porous mould and may be dried.

Alternatively the article may be dried in situ. Preferably this is first done with compressed air at ambient temperature which is made to oscillate in pressure. This reduces the water content from 75% to 30-35%. This oscillating action is particularly good at dislodging water from inside hollow pulp fibres. A second drying step is to apply pressurised hot air, typically 1-2 bar, which passes through the moulded fibre material reducing the water content to 5-8%.

There are various spherical materials available from which suitable pulp moulding filters can be manufactured, glass, plastics, ferrous and non-ferrous metals, the latter proving to be the most suitable owing to its tensile strength and corrosion characteristics.

Each spherical material may require a different bonding technique that will ensure a uniform mechanical structure and porosity.

The manufacture of filters, for other purposes, constructed using phosphor bronze spheres to provide small simple geometric shapes, (as used for pneumatic air filters), is already commercially known art and normally uses a simple single ‘master mould’ component to contain the spheres during the heat treatment process.

Construction of such porous filters is achieved by using vibration to compact the phosphor bronze spheres in a ‘master mould’ usually constructed of a material having a low coefficient of expansion and a significantly higher melting point than that of phosphor bronze material.

In order to commercially produce more complex and intricate porous filter shapes a different technique, illustrated in FIGS. 6A to 6C, is proposed. The ‘master mould’ 60 in accordance with the invention comprises ‘male’ (or ‘core’) 61 and ‘female’ (or ‘cavity’) 62 components, shaped to the desired three dimensional profile to provide a cavity with a preferably uniform distance between the two faces against which the phosphor bronze spheres are retained while the heat treatment takes place. (The uniform thickness of the mould thereby produced ensures uniform thickness of the paper fibre layer produced when using the mould.)

The process commences (FIG. 6A) with the master mould clamped together and vibrated while the phosphor bronze spheres 63 are poured in through a suitably located aperture 64 connecting it to the cavity inside. This compacts the spherical material ensuring a uniform structure and porosity on completion of the process.

The ‘master mould’ containing the phosphor bronze spheres is then uniformly and gradually heated to a controlled temperature typically between 600° C. and 700° C. The compaction of the spheres and the heat causes them to fuse, or sinter, together. Before the spheres enter a liquid state the mould is then gradually cooled (FIG. 6B). FIG. 6C shows the final mould with the arrows indicating the moulding surface.

The heat treatment process causes some slight distortion of the spheres but this is insignificant and has little or no effect on the performance of the filter material for this application. The cavity portion of the mould can be machined from a block of carbon, which is a good conductor of heat and which is stable at the temperatures of around 650° C. that are used in the sintering. A relative contraction of the finished mould compared to the master mould after cooling is indicated in FIG. 6B. The male part 61 of the master mould is therefore made of a compressible material (whether that be resiliently compressible or deformably compressible (e.g. soft clay or plaster)).

FIG. 7 shows a method by which moulds may be assembled from sections. The sections 67, 68 are made by any of the methods described above. Each section may, as shown in the Figure, be preformed to have filter faces at different angles, or may be simple flat sections The sections are butted together and then are welded together, for example by laser welding or plasma welding (the latter being preferred for phosphor bronze sections). This method of fabricating a mould overcomes the disadvantage of sintering processes, in which many sintering ovens are small, allowing sections of only 10-15 cm in dimension to be fabricated. It also overcomes the problems of sintering larger objects where the pore size can be uneven (which would lead to uneven thickness of pulp deposition) caused either through uneven heating or the weight of the mould particles pressing down during sintering.

As shown in the magnified portion of FIG. 7, the width of the weld (the dark section) is typically 1.0-1.5 mm for laser welding. Welding is preferably done from the outside surface of the mould so as to minimise damage to the inside moulding surface of the mould.

This method is particularly useful for creating when creating moulds too deep to made by the techniques described above. (Even the technique of FIG. 6 may have its limitations because if the mould is too deep the weight of the bronze spheres may compact the lower layers closing the pores between them.

Generally, the surface of the filter formed from such spheres provides a uniform ventilated area, an important requirement in ensuring the final formed fibre coating has an even density and thickness.

The size of aperture formed at the point where any three spheres meet can be chosen by increasing or decreasing the diameter of the spheres used accordingly. FIG. 8 shows a graph plotting the diameter of phosphor-bronze spheres against the air passage cross-sectional area between them after sintering. FIG. 8A shows the location of the apertures 81 in the filter.

This aperture size should generally be chosen appropriately to accommodate higher filtering pressures (up to 10 bar), the size and length of fibre material being filtered, fibre mass to water ratio (normally 1:99 respectively), fines and other miscellaneous matter usually found in re-cycled pulp fibre materials. (“Fines” is a term of the paper making arts and includes matter such as clay, ink particles etc.) Normally a sphere size of between 0.6 and 0.7 mm is suitable. Smaller pores might become blocked and larger ones will produce a rough surface finish to the article, which may not always be desirable.

A surface constructed from spheres in this way also provides a solid stable area, without having any undercuts or sharp edges that would possibly trap, or grip, the fibre material to the surface of the filter. FIG. 8C shows a layer of paper fibres on a traditional wire mesh filter and the undercuts 82 that lock the paper article to the mesh. (Our experiments show that undercuts would form on a traditional wire filter if pressure, as is preferred in the invention, is applied to the article in excess of 0.8 bar.) As the fibre mass is drawn on to the spherical-particle surface of a filter according to the invention (FIG. 8B) it is caused to compress at the entrance to each aperture 81, where any three spheres meet.

The convex surface, or dome, effect each sphere creates permits steeper draft angles to be achieved on deeper and more intricate moulded shapes. (A “draft” angle is the angle off the vertical that opposing vertical sides of an article need to be in order to release from the mould.) The surface structure of the filter greatly assists removal of the finished component from the mould, as the vertical faces of the component compress, ride up and slide over the surface of the spheres.

Using such a filter material to form and shape pulp fibres provides great energy saving benefits, dramatically improving the conventional wire screen process and eliminating the three main elements which contribute to excessive use of energy normally required with conventional pulp moulding processes. These are (a) the use of a hydro-pulper, (b) vacuum, and (c) drying ovens.

(Note that some spheres are produced by chopping nickel plated copper wire into lengths similar to their diameter, which results in material in the form of short cylinders; the term “sphere” used herein covers that form of material. However this can produce particles of more consistent size and shape than some alternative methods of producing spheres.)

The hydro-pulper which is used in a conventional moulding process breaks down sheet paper or board into pulp moulding stock, separating the material into individual fibres. This takes approximately 10-15 minutes to achieve before the pulp furnish is suitable for vacuum forming on to wire screen moulds.

The fibre water mix used in the invention preferably has a ratio of 1:99 respectively. Any much greater than this and the materials flow characteristics are reduced and it becomes difficult to transport the suspended fibre material and to achieve an even coating on the mould. (Ratios of between 0.5:99.5 to 1.5:98.5 are expected to be the preferred range of fibre to water.)

For the use of the sphere moulds a new form of moulding apparatus has been developed. (For production runs a sintered phosphor-bronze mould would generally be used, but one made of glass or acrylic spheres, while less durable, could be used for prototyping.) An example of this apparatus is shown in FIGS. 9 to 15. The illustrated apparatus comprises a moulding chamber assembly which comprises an upper chamber 114 and lower chamber 110, separated through the chain dotted line shown in FIGS. 9 and 10. The opposing faces of these two chambers are held clamped and sealed together in a press or similar apparatus.

Upper chamber 114 has a circumambient side wall divided by an apertured plate 104. A cover plate is bolted to the upper face of the side wall and sealed thereto by O-rings 113. A supply port 101 is provided in the cover plate, as is an outlet port 102 and the space between the cover plate and the apertured plate 104 forms a manifold 103.

Lower chamber 110 is formed by a generally cylindrical open topped cup in the lower part of which a piston 109 is mounted on a shaft connected to an hydraulic cylinder 112. Piston 109 forms a liquid tight seal with the interior of the cup by virtue of further O-rings 113a. A backwash liquid inlet port 111 is formed by a pipe entering through a hole in the base of said cup and terminating in threaded engagement in a bore in the piston 109.

Above the piston 109, a mould 107 is received on an annular ledge in the top of said cup and is clamped in position by a ring 106 trapped between the upper chamber 114 and the lower chamber 110 and sealed by upper and lower O-rings 113b.

The space between the piston 109 and the mould 107 forms a backwash chamber 108 whilst the space between the mould 107 and the apertured plate 104 forms a moulding chamber 105.

Commencing the cycle at “backwashing” with piston 119 at position “B”, pulp inlet port 101 closed and inlet/outlet port 102 allowed to exhaust, backwash chamber 108 is filled with “clean” water to the base of the filter 107 via inlet/outlet port 111. With inlet/outlet port 111 closed, piston 109 is rapidly extended to position “A” using hydraulic cylinder 112, forcing an even pressure of “clean” water through the entire surface of the mould or filter 107 and into the moulding chamber 115 immediately above.

Component moulding is initiated by closing inlet/outlet ports 102 and 111 and opening pulp supply port 101. As piston 109 is slowly retracted from position “A” to position “B” by means of cylinder 112, the incoming pulp enters the moulding chamber 105 via the pulp distribution manifold 103, mixing with the backwash water, the piston drawing the pulp fibres evenly on to the mould surface.

By repeating this moulding sequence, using piston 109 in conjunction with opening and closing inlet/outlet ports 101 and 102 at the appropriate time in the piston's stroke, additional layers of pulp fibre material can be drawn evenly on to the mould surface until the desired fibre build up has been achieved. The additional layers of pulp fibre can be drawn from alternative stock through the same inlet port 101 as shown in schematic in FIG. 16.

Being able to vary composition of the subsequent layers of pulp fibre material provides additional benefits not possible using current moulding techniques. For example; the initial fibre coat to be deposited on the mould surface could be a “white” virgin pulp material providing a good finish and appearance, this could then be followed by a “grey” less expensive recycled material to provide the strength required.

Being able to vary the type and size of pulp stock, its thickness and colour can also produce some very desirable structural and decorative results.

First stage drying, or water extraction, is initiated while the component still remains in the mould, enabling 50-60% of the water to be extracted before the component is finally ejected for final form drying and the moulding cycle commences again with the backwash programme.

With pulp supply port 101 closed, piston 109 at position “B” and inlet/outlet port 111 open to drain water, heated compressed air (in this example at 60-70° C. at 7-10 bar) is forced into the moulding chamber 105 via manifold 103 for about 3-10 seconds depending on component thickness. This forces water from the moulded component and heating it at the same time, causing further evaporation to occur when the mould chamber is opened.

Recent experiments at higher temperatures have, however, indicated that more efficient operation can be had by heating the compressed air to 400-500° C. and supplying it in the range 1-2 bar. This reduces the energy required to perform the drying and because the temperature is much greater the drying is quicker and the cycle time for the production of an article is reduced. (Note that this temperature is too high if the mould is made of glued together spheres since it will damage the mould.)

Ejection of the finished component is initiated with backwash chamber 108 fully drained, piston 109 still at position “B” inlet/outlet port 111 closed and the top of chamber 114 containing inlet/outlet assembly 101 and 102 removed (FIG. 11). Piston 109 is rapidly extended by means of cylinder 112, compressing the air behind the finished moulded component causing it to eject from the filter surface. Synchronous to this, it is collected and transferred by a transporting head 115, shown in FIG. 11, for post drying.

One advantage of the this moulding system is that the article is dried in situ on the mould. This results in there being no or very little shrinkage. This makes design of the mould simpler because the mould can be shaped and sized directly to the shape and size of the desired article without having to allow for shrinkage.

Completion of the ejection sequence and final drying process is illustrated through FIGS. 11 to 15. The ejected component 117 (FIG. 11), is transported free of the moulding chamber by a similarly shaped complementary form 116, also constructed from a porous spherical filter material having a typical ball size of 0.5-1.0 mm diameter. Suction is applied via inlet/outlet port 118 holding the moulded component against the transporting head 115 during its transportation to the drying chamber 119 FIG. 12. At this location it is ejected by reversing the pressure via inlet/outlet port 118 from suction to blow, transferring the finished moulded component 117 in to the drying chamber 119.

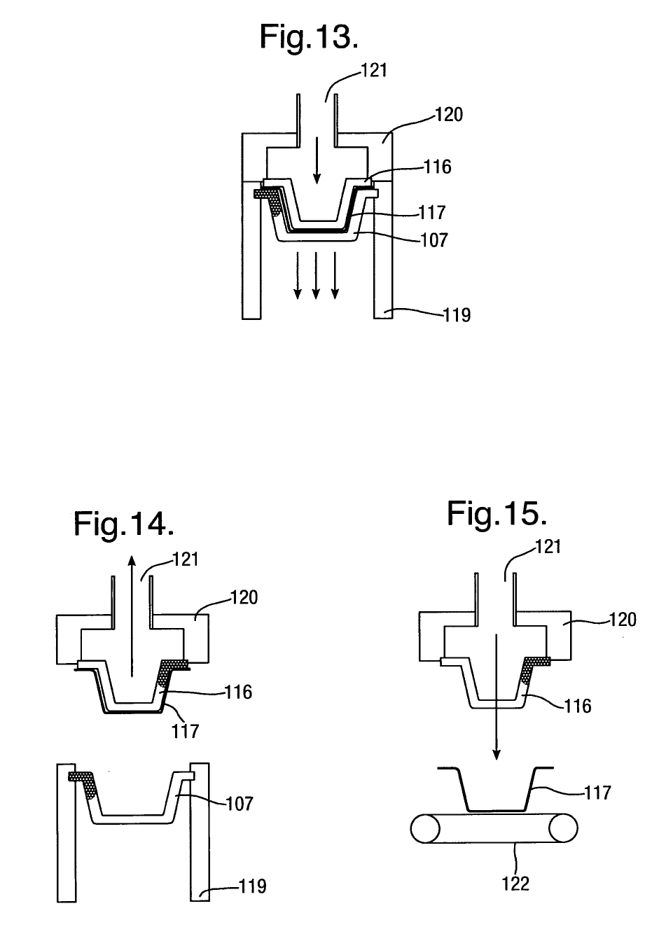

FIG. 13 shows the moulded component 117 clamped between the two opposing mould filters 116 and 107 in the upper and lower chamber assemblies, 120 and 119 respectively. Heated compressed air is applied through inlet/outlet port 121 which is forced through the fibres of the moulded component 117 drying the moulding until 5-7% water content is achieved. Again this drying of the article on shaped moulds eliminates any mis-shaping or shrinkage of the finished component, a major problem found with conventional moulding and drying processes which there is only overcome by a post hot pressing method using expensive machinery and additional tooling.

FIG. 14 shows the finished dried component 117 being removed from the drying chamber using the upper assembly 120 with suction being applied via inlet/outlet port 121.

FIG. 15 shows the finished dried moulded component 117 being transported and ejected on to a conveyor 122 for packing and transportation.

In the recent tests using the first stage drying in the mould 107 at a temperature of 400-500° C. and a pressure of 1-2 bar was found to reduce the water content to a level (5-8%) sufficient for most purposes the separate drying stage of FIGS. 12 to 14 was not used, providing no additional benefit.

As mentioned previously, conventional pulp preparation commences within a “Hydro-pulper”. This piece of apparatus comprises of a large cylindrical shaped chamber which can measure up to 8 metres diameter×4-5 metres deep, having a large two blade rotor which slowly rotates at its base. This rotor breaks down the waste paper into individual fibres with the aid of water to a determined viscosity, typically 5 parts paper to 95 parts water in conventional paper making. This process can take up to 10-12 minutes to complete before the material is suitable for processing through a “de-flaker”, a device used to further refine the pulp fibre furnish before it is used.

A device of such physical size is needed to be able to process large volumes of paper by allowing the speed and movement of the rotor to break down the solid paper mass as it stirs and rubs against itself, breaking it into individual pulp fibres.

Such a conventional hydro-pulper can be used to supply the pulp to the moulding apparatus of the present invention but, as shown for the example apparatus of FIG. 16, a liquidizing process described later below is preferred.

FIG. 17 shows an alternative form of the moulding apparatus 1700. For ease of comparison with the apparatus of FIG. 9, similar parts have been given similar reference numerals, namely having the same last two digits. The apparatus has a cylindrical body 1710 containing a reciprocating piston 1709, the body and piston defining a lower, or backwash chamber 1708. The piston is moved by means of a hydraulic ram 1712.

As is generally preferred for pistons, the piston and body are circular in cross section. A cylinder head 1714 of similar cross section to the body is mounted above the body on a hydraulic ram 1530, the end of which is attached to a plate 1731 that closes the upper end of the cylinder head. The opposing faces of the cylinder head and the body may be are held clamped and sealed together through force exerted by the ram 1730 or the ram may withdraw the cylinder head to allow removal of the moulded article, or replacement of the mould.

A pulp supply port 1701 is provided in the side wall of the cylinder head, as are a hot air inlet/exhaust outlet port 1702 and a cold air inlet port 1732. The manifold 1733 leading to the port 1702 branches into conduits 1735 and 1734 for the supply of hot air and leading to an exhaust respectively. The hot air is supplied from a 30 kW heat exchanger 1743, this may very in kW power and would be proportional to the surface area of the moulded product being dried.

In the lower chamber 1708 the piston 1709 is cup shaped and forms a liquid tight seal with the interior wall of the body by virtue of O-rings 1713. A backwash liquid inlet port 1711 is formed by a hole in the base of said cup having a conduit leading to it from the underside of the piston. The piston is similarly provided with a drain outlet port 1744 and conduit leading from that.

Above the piston 1709, a mould 1707 is received on an annular ledge at the top of the body 1710 and is clamped in position by the lower edge the side wall of the cylinder head 1714. The lower edge is provided on an annular protrusion at the lower end of the side wall of the cylinder head, which protrusion fits inside the upper end of the side wall of the body.

The cylinder head is also provided with a silicone rubber former 1737. This is complementary in shape, or is at least generally so, to the shape of the mould 1707. The former can be moved into engagement with the mould by means of twin pneumatic cylinders 1738 mounted on top of the cylinder head plate 1731 whose shafts pass trough holes in the plate to the former 1737 inside the cylinder head.

The space between the piston 1709 and the mould 1707 forms the backwash chamber 1708 whilst the space inside the cylinder head between the mould 1707 and the former 1737 forms a moulding chamber 1705.

The pulp supply port 1701 is connected by a conduit to a shot chamber 1739, which has a port 1740 for filling it with paper pulp (e.g. from a liquidizer) and a port 1742 for the introduction of additives.

Additives can include colourings, herbicides, germicides and beeswax (for water-proofing) etc.

The apparatus is operated as follows.

Commencing the cycle just before “backwashing”, the cylinder head 1714 is lowered into engagement with the mould sealing moulding chamber 1705. At this point piston 1709 is at its lower position B and all the ports are closed except exhaust 1702/1734. Backwash inlet port 1711 is opened and backwash chamber 1708 is filled with “clean” water to the base of the mould 1707. With inlet/outlet port 1711 then closed, piston 1709 is rapidly extended to its upper position A using hydraulic ram 1712, forcing an even pressure of “clean” water through the entire surface of the mould 1707 and into the moulding chamber 1705 immediately above, which releases any fibres or fines from the surface of the mould, which might otherwise clog it. Just enough backwash liquid is used to cover the mould 1707 when the piston is at its upper position A. It may also be desirable, for example on larger moulds, to charge the backwash with an ultrasonic pulse to assist in the removal of any contaminants.

While this is occurring shot chamber 1739 is filled with the correct amount of pulp for the article via port 1740, which amount is determined by weight sensor 1741. additives such as those mentioned above can be added into the pulp shot via port 1742 if desired.

Component moulding is initiated by closing port 1711 and opening pulp supply port 1701. With exhaust port 1702 still open the charge of pulp enters the moulding chamber and mixes with the backwash water containing the matter washed from the mould. (The backwash water does not need to be disposed of; the backwashing has already served its purpose of unclogging the mould and its contents can mix with the pulp shot without detrimental effects.

As piston 109 is then retracted from its upper to its lower position by means of ram 1712, this cause a vacuum below the filter mould drawing the pulp fibres evenly on to the mould surface, most of the water in the pulp passing through the mould into the backwash chamber 1708. The drain port 1744 in the cylinder is then opened for a period in order to remove the water in the backwash chamber.

By repeating this moulding sequence, additional layers of pulp fibre material can be drawn evenly on to the mould surface until the desired fibre build up has been achieved. The additional layers of pulp fibre can be drawn from alternative stock sources. Between layers the piston can be repositioned to its upper position by advancing it with exhaust port 1744 open so that air in the backwash chamber 1708 is expelled via that rather than being pushed through the mould undesirably releasing the layer(s) of pulp from the mould.

Again, being able to vary composition of the subsequent layers of pulp fibre material provides additional benefits not possible using current moulding techniques. For example; the initial fibre coat to be deposited on the mould surface could be a “white” virgin pulp material providing a good finish and appearance, this could then be followed by a “grey” less expensive recycled material to provide the strength required.

Being able to vary the type and size of pulp stock, its thickness and colour can also produce some very desirable structural and decorative results.

Once the desired number of layers (one or more) have been deposited on the mould the silicon rubber former 1737 is pressed, by means of pneumatic cylinders 1738, into the pulp surface to produce a smooth finish or decorative texture as desired.

Air drying, or water extraction, is then carried out with the component remaining in the mould. As noted above, experiments have indicated that efficient final drying can be achieved by heating compressed air to 400-500° C. and supplying it in the range 1-2 bar. The compressed air is supplied via heat exchanger 1743 and manifold 1733; from there it passes though the article and mould 1707, exiting via port 1744. This uses less energy and because the temperature is high the drying is quicker and the cycle time for the production of an article is reduced. Further energy can be saved by preceding the high temperature drying with ambient pressurised air, preferably made to oscillate. This can be used to reduce the water content to 30-35% before the final hot air drying, which as a result can be of shorter duration, which reduces the water content to 5-8%.

While the air drying temperature of 400-500° C. has been found to be advantageous, a higher temperature of 500-600° C. will dry more quickly. In general a range of 400-800° C. will be preferred.

As noted above the preferred pressure of the drying air is not as high as first thought, which may be because at high pressures the air is forced through too fast to be efficient; generally a range of 0.5-2 bar is preferred.

Ejection of the finished component is initiated with backwash chamber 1708 fully drained, piston 1709 still at position “B”, ports 1744 and 1711 closed and the top of chamber 1714 removed. Piston 1709 is rapidly extended by means of cylinder 1712, compressing the air behind the finished moulded component causing it to eject from the filter surface. Synchronous to this, it is collected and transferred by a transporting head (not shown in FIG. 17 but see FIG. 13. Generally the high temperature in-mould drying is sufficient and the article is left to dry off in the ambient air before being stacked.

Depending in the article the drying in the mould apparatus may also include a stage of cold air drying. The cold compressed air for that is supplied via port 1532.

The moulding cycle commences again with the backwash programme.

FIG. 17 also shows a split mould 1707′ (in this particular case for a bottle) that can be used in the apparatus of FIG. 17. This has a pair of semicircular plates for mounting on the ledge at the top of the body 1710. The two halves of the mould depend from the respective plates and are held together by a latch 1740 during moulding and drying. The mould is removed from the apparatus manually, opened and the moulded article removed manually. FIG. 17B shows the mould halves separated and the moulded item removed, again manually.

FIG. 17a shows an arrangement of the piston for generating vacuum and/or compressed air. This utilises the hydraulic ram 1712 as the power source, thereby combining it efficiently with the power source for the functions of the piston described above. A further chamber 1750 is formed on the other side of the piston from the mould by an end plate 1751 mounted to close off the space surrounded by cylindrical body 1710. The backwash chamber 1708 remains, of course, on the other side of the piston. (In the particular arrangement shown in FIG. 17a the piston is mounted horizontally and the part of the backwash chamber shown in the FIG. 17a narrows to a connecting pipe 1761 that, although not shown, turns through a right angle before widening to another portion of the backwash chamber where the mould 1707 is mounted in the same manner as FIG. 17.

Vacuum is generated when the piston is moved towards the mould 1707 and then is transferred to a vacuum reservoir 1752 by opening briefly a valve 1753 to the chamber 1752. Air is then let into the chamber 1750 via a valve 1754 leading to the open air. That valve is closed and then, as the piston is moved away from mould, a valve 1755 connecting the chamber 1750 to a compressed air reservoir 1756 is opened and the air in the chamber 1750 is pumped into the reservoir.

Meanwhile on the other side of the piston the moulding operations are carried out as described previously. In this arrangement, compared to that of FIG. 17, ports 1711 and 1744 have been moved from being through the piston to being through the wall of the body 1710. Conveniently as mentioned, the piston section of the body is mounted generally at a right angle to the section of the body containing the mould, which allows port to 1744 to be positioned at the lowest point for drainage.

Vacuum and compressed air stored in the reservoirs is supplied as described above for the operations of the moulding cycle. If in some particular arrangement the vacuum or compressed air generated can be used immediately (either in the moulding machine of the piston that generated them or in a parallel moulding machine) then a reservoir for that is not necessary.

FIG. 18 shows another form of moulding apparatus, which is suitable, for example, for closed articles such as a bottle. This is similar to that of FIG. 4 in that it is a mould in two halves. Similar ports to that of the apparatus of FIG. 16 are used so that it can be used instead of the cylindrical chambers in an overall moulding machine. It is thought simpler to use this mould with automatic opening and closing of the two mould halves rather than to arrange for that with the split mould shown in FIG. 17 itself.

The mould comprises a mould box 20′ in two halves 1852, 1853 each comprising half the porous mould (in this case for a bottle). One half 1853 is mounted on a hydraulic ram (not shown) so that it may be moved into and out of engagement with the other mould half. When the two halves of the box are closed together so are the two halves of the mould 1707′. A head 1850 is biased down onto a port 1754 in the top of the box which communicates with the space surrounded by the moulding surface of the mould 1707′. (The head may be mounted on ram 1730 (FIG. 17) for the purpose.) In the case of a bottle this communication is via the neck of the bottle which leads down from the port 1754. The head provides connections to the pulp shot chamber 1739 via port 1701′ and to the supplies of hot and cold compressed air via port 1702′ and manifold 1733′.

In this example there is no piston so once the pulp shot is introduced inside the bottle mould the water from the pulp mix is drawn through the mould by applying vacuum on the other side via port 1744′. Backwashing is performed by introducing the backwash water via the port 1711′ under pressure (rather than providing the pressure with the piston). As with the apparatus of FIG. 17 the water is removed using compressed air supplied via port 1702′, with similar temperatures and pressures being preferred.

The moulded article is removed from the mould by opening the two halves. Preferably the mould has in one half (preferably 1853 which moves away from the static half 1852, which has most of the pipe work) with an undercut in its shape, which means that that half retains the moulded article. The article is then ejected using a blast of compressed air (supplied via a port 1851 connecting to the space between the box and the mould, the gap between which is closed off with a wall close to the edges of the box and the mould that mate with the other halves—ports 1711′ and 1744′ are duplicated in mould half 1853). Alternatively the article may be ejected mechanically.

We have now established that it is far more efficient and practical to convert paper and board waste using a liquidising process to provide a similar ready to use pulp furnish. This process is faster and more efficient as the material can be prepared and supplied on demand relatively quickly, to suit the size and thickness of components being moulded.

The liquidising process commences with first shredding the waste paper/board into strands typically 5-10 mm wide, during this initial stage of the process any ferrous materials are magnetically removed. The paper/board material is conveyed using water to the liquidising chamber in the preferred proportions of around 1:99 paper and water respectively. At this point the mix is rapidly broken down into individual fibres by 2-4 blades rotating at high speed, typically 5,000-10,000 revolutions per minute depending on the density and composition of material being prepared.

FIG. 19 shows an example of the liquidizing apparatus in detail, which may be used with any of the examples of moulding apparatus described above. The paper is shredded with a cross cut shredder 1901, which is then measured in batches into a set of parallel liquidizers 1902, which use blades to liquidise the paper. Water is then added into the liquidizers in the desired ratio. (Waste water from the moulding chamber can be recycled here.) Once the pulp fibres reach a desired size, valves 1903 are opened and the mixture, passing through sieves 1904, enters the tank 1907 Here it is kept mixed by air agitation, which also keeps the fibres in suspension. Air for the agitation is provided by an air line 1906 passing across the shot chamber near it bottom and having a set of holes in it to provide bubbles. (Drying air from the moulding chamber can be recycled here.) Valve 1905 is opened to provide pulp to the shot chamber 139. as an alternative to adding additives to the shot chamber 139 additives can be added into the pulp in the tank via port 1742′.

FIG. 20a shows an alternative form of liquidiser to that shown in FIG. 19, which used blades to liquidise the pulp. In the liquidiser of FIG. 20a there are no sharp blades but instead an liquidising head 2000 comprising a section of tube 2005 with an array of slots formed therein. While this device is known as a mixer for other purposes, its use as a liquidiser for pulp fibres is new.

The tube wall, through which the slots are formed is 2.5 mm in thickness and the slots are 3 mm by 4 mm. A flange extending out from the tube is also provided attached to the tube above the slots and having a series of holes therethrough. A cruciform paddle (see FIG. 20b and the cut-aways in FIG. 20a) is provided inside the liquidising head. The head is rotated at around 400 rpm inside a container 2010 of shredded paper (fed in the same way as in Figure . . . ). The preferred rotation speed may be 200 rpm to 500 rpm, depending on the material.

The head is moved about the container to ensure that all parts of the suspension are processed. As shown in FIG. 20c two or more slotted sections 2005, 2005′ of tube can be provided to increase the interaction between the agitator and the pulp.

This form of liquidization produces bent pulp fibres, and it is notable that the fibres produced remain in suspension for at least 24 hours. (This contrasts to the bladed liquidiser, which produces straight fibres which, as with the traditional hydro-pulper, settle easily, needing agitation to keep them suspended.) The bent fibres produce stronger bonding across the pulp layer of the finished article than the straight fibres because the bent fibres become matted together.

One advantage of the bent fibres produced by the slotted liquidiser is that it may block the mould less because the straight fibres produced by other techniques will tend to align with the liquid flow during moulding, the liquid drawing the fibre ends into the pores of the mould.

The fibres produced by the slotted mixer are also useful in the production of paper sheets, such as art paper and blotting paper and so this technique is useful in paper making and pulp article making processes other than those described herein.

In the examples above only a single moulding chamber has been shown. For greater production volumes several cylinders can be provided fed from a common pulp liquidizer and supplies of hot and cold air. The cylinders are then operated in offset phases, which is efficient as the supplies of pulp and air can be used in turn round the cylinders making their outputs more continuous.

Different articles will have different moulds but also will need different amounts of pulp, number of layers, types of additive, drying regimes etc. The apparatus can be computer controlled to facilitate that. Further each mould can be marked with an ID (either machine readable—such as an RFID tag or barcode—or human readable for keying in) to which the computer responds by operating the apparatus to suit the article to be produced by the mould. In a multi-cylinder machine different cylinders can produce different articles.

To produce structural components for cladding applications for the building, automobile and aerospace industries, which are lightweight and have inherent strength, alternative methods can be employed to produce such components.

The principles are similar to those previously mentioned with the exception of coating the filter surface. With larger components it is not necessarily practical to coat the filter surface using suction, an alternative solution to this problem would be to spray coat the filter material using conventional spraying equipment suitably adapted. This can be achieved either by applying moulding materials by hand or using robotics, layering various compatible component materials to provide the desired strength and finish.

For example: a first coat of pulp fibre material is applied to the mould or filter surface. While still wet a second coat of wet natural fibre material such as hessian or jute is fired at the surface, similar to the process as used to produce large glass fibre components. As alternate layers are applied the component thickness and strength increases to produce the desired result.

Other additives can also be added to the pulp furnish mix such as colouring, waterproofing, fire retarding etc., prior to its application on to the filter surface.

The final composite construction is sandwiched between two complementary shaped filters for final drying.

Whilst the invention has been described with reference to the specifically illustrated embodiments, many variations and modifications thereof are possible within the scope of the invention.

1. A method of forming a moulded article comprising:
feeding a suspension of particles in a suspending liquid to the moulding surface of a porous mould comprised of bonded particles,
removing said suspending liquid via the pores of said porous mould to deposit said suspended particles on said mould surface as a shaped article, and
passing air above ambient temperature through the deposited suspended particles and the porous mould from the side of the porous mould on which the particles are deposited,
wherein the air applied to the mould is applied via a sealed chamber over said mould surface.

2. A method as claimed in claim 1 wherein the suspended particles are fibres.

3. A method as claimed in claim 2 wherein the suspended particles are cellulosic fibres.

4. A method as clamed in claim 2 wherein the suspended particles are paper fibres.

5.-10. (canceled)

11. A method as claimed in claim 1 wherein the bonded particles are nickel coated copper.

12. A method as claimed in claim 1 wherein the suspending liquid is forced through the mould by applying a pressure difference across the mould.

13. A method as claimed in claim 12 wherein the suspending liquid is forced though the mould by applying suction to the opposite side of the porous mould to that to which the suspended particles are fed.

14. A method as claimed in claim 13 wherein the suction is applied though the action of a piston in a chamber closed off by the mould.

15.-19. (canceled)

20. A method as claimed in claim 1 wherein the air passed is at a pressure of 1 to 2 bar above atmospheric pressure on the deposition side of the mould and a temperature of 400° C. to 500° C.

21. A method as claimed in claim 1 wherein the air passed is at a pressure of 7 to 10 bar above atmospheric pressure on the deposition side of the mould and a temperature of 60° C. to 70° C.

22. A method as claimed in claim 1 wherein the air passed is a temperature of 400° C. to 800° C.

23. A method as claimed in claim 1 wherein the air passed is a temperature of 400° C. to 500° C.

24. A method as claimed in claim 1 wherein the air passed is a temperature of 500° C. to 600° C.

25. A method as claimed in claim 1 wherein the air passed is at a pressure of 0.5 to 2 bar above atmospheric pressure on the deposition side of the mould.

26. A method as claimed in 1 wherein the air passed is at a pressure of 1 to 2 bar above atmospheric pressure on the deposition side of the mould.

27. A method as claimed in claim 1 comprising placing the moulded article between two porous moulds and passing heated compressed air through the moulds and the article.

28.-30. (canceled)

31. A method as claimed in claim 1 comprising passing a backwash liquid through the mould in the opposite direction from that in which the suspending liquid passed through the mould.

32. A method as claimed in claim 31 comprising introducing ultrasound into the backwash water passing through mould.

33.-36. (canceled)

37. A method as claimed in claim 1 comprising pressing a flexible impermeable membrane against the article using pressure applied behind the membrane.

38. A method as claimed in claim 37 wherein the membrane forms an internal screw thread into the article.

39.-47. (canceled)

48. A moulding machine comprising:
a porous mould comprised of bonded particles;
a chamber sealed over the moulding side of the mould;
a supply of compressed air above ambient temperature connected to supply to said chamber.

49. A moulding machine as claimed in claim 48 wherein the particle size is between 0.5 and 0.7 mm.

50. A moulding machine as claimed in claim 48 comprising a port for feeding a suspension of particles to the moulding side of the mould.

51. A moulding machine as claimed in claim 48 comprising a cavity to the other side of the mould, and a port for applying suction to the cavity.

52. A moulding machine as claimed in claim 48 comprising a cavity, to the other side of the mould, receiving the mould, and a piston for applying suction to the cavity and hence to the mould.

53. A moulding machine as claimed in claim 52 comprising a pump cavity located on the other side of the piston from the side where the mould is located, the pump cavity being connected to supply vacuum, or being connected to supply compressed air, or being connected to supply vacuum and compressed air.

54. (canceled)

55. A moulding machine as claimed in claim 51 comprising a port for supplying backwash water into the cavity.

56. A moulding machine as claimed in claim 48 comprising a port for supplying compressed air to said one side of the mould.

57. A moulding machine as claimed in claim 48 comprising a former advancable into the face of the mould on the one side.

58. A moulding machine as claimed in claim 48 wherein the mould is in at least two separable parts.

59.-87. (canceled)

88. A method of forming a moulded article comprising:
feeding a suspension of particles in a suspending liquid to the moulding surface of a porous mould comprising bonded particles,
removing said suspending liquid via the pores of said porous mould to deposit said suspended particles on said mould surface as a shaped article, and
passing a backwash liquid through the mould in the opposite direction from that in which the suspending liquid passed through the mould.

89. A method as claimed in claim 88, further comprising introducing ultrasound into the backwash water passing through the mould.
